(19) United States
(12) Patent Application Publication
(10) Pub. No.: US 2025/0181262 A1
(43) Pub. Date: Jun. 5, 2025

(54) STORAGE DEVICE SUPPORTING FLUSH OPERATION AND OPERATION METHOD THEREOF

(71) Applicant: SAMSUNG ELECTRONICS CO., LTD., Suwon-si (KR)

(72) Inventors: JEONGMIN JO, Suwon-si (KR); KYUNG-HO SHIN, Suwon-si (KR); Jaeguk AHN, Suwon-si (KR); JAESUB KIM, Suwon-si (KR); JUNG-GYU KIM, Suwon-si (KR); JUNYONG UHM, Suwon-si (KR)

(73) Assignee: SAMSUNG ELECTRONICS CO., LTD., Suwon-si (KR)

(21) Appl. No.: 18/934,427

(22) Filed: Nov. 1, 2024

(30) Foreign Application Priority Data
Dec. 5, 2023 (KR) 10-2023-0174893

(51) Int. Cl. G06F 3/06

(52) U.S. Cl. CPC G06F 3/0646; G06F 3/0619; G06F 3/0683

(57) ABSTRACT

A storage device supporting a flush operation among multiple namespaces, the storage device includes: a volatile memory configured to temporarily store a plurality of pieces of data received from a host device; a non-volatile memory device including a plurality of namespaces; and a controller configured to perform a flush operation in response to a flush command received from the host device, wherein the controller is further configured to, in the flush operation, move at least one piece of data, stored in the volatile memory and corresponding to the flush command, to at least one of the plurality of namespaces of the non-volatile memory device in a unit smaller than or equal to a namespace.

### CROSS-REFERENCE TO RELATED APPLICATION(S)

This application claims priority under 35 USC § 119 to Korean Patent Application No. 10-2023-0174893, filed on Dec. 5, 2023, in the Korean Intellectual Property Office, the disclosure of which is herein incorporated by reference in its entirety.

### BACKGROUND

One or more example embodiments of the disclosure relate to a storage device, and more particularly, to a storage device supporting a flush operation and an operation method thereof.

A semiconductor memory device is a memory device implemented using a semiconductor such as silicon (Si), germanium (Ge), gallium arsenide (GaAs), or indium phosphide (InP). In general, semiconductor memory devices are classified into volatile memory devices and non-volatile memory devices.

Recently, research into a storage device supporting a namespace function for providing a plurality of logical devices from a single physical device has been conducted. In the case of a storage device supporting the namespace function, a flush operation is performed in a unit of a namespace. As a result, the performance of the flush operation of the storage device is limited.

### SUMMARY

One or more example embodiments provide a storage device for improving performance of a flush operation while supporting a namespace function and a method of operating the storage device.

According to one or more example embodiments, provided is a storage device supporting a flush operation among multiple namespaces, the storage device including: a volatile memory configured to temporarily store a plurality of pieces of data received from a host device; a non-volatile memory device including a plurality of namespaces; and a controller configured to perform a flush operation in response to a flush command received from the host device, wherein the controller is further configured to, in the flush operation, move at least one piece of data, stored in the volatile memory and corresponding to the flush command, to at least one of the plurality of namespaces of the non-volatile memory device in a unit smaller than or equal to a namespace.

According to one or more example embodiments, provided is a storage device supporting a flush operation among multiple namespaces, the storage device including: a volatile memory configured to temporarily store a plurality of pieces of data received from a host; a non-volatile memory device including a plurality of namespaces; and a controller configured to perform a flush operation to move at least one piece of data, stored in the volatile memory, to the non-volatile memory device in response to a command received from the host, wherein the non-volatile memory device includes a first namespace, a second namespace, and a third namespace, wherein the controller includes: a first non-volatile memory (NVMe) controller corresponding to the first namespace and the second namespace and configured to perform a first flush operation and a second flush operation on the first namespace and the second namespace; and a second NVMe controller corresponding to the second namespace and the third namespace and configured to perform a third flush operation and a fourth flush operation on the second namespace and the third namespace, wherein the first NVMe controller, the second NVMe controller, the first namespace, and the third namespace correspond to a first domain, wherein the second namespace corresponds to a second domain, different from the first domain, and wherein a unit of moving the at least one piece of data in the first flush operation and the fourth flush operation corresponding to the first domain is different from a unit of moving the at least one piece of data in the second flush operation and the third flush operation corresponding to the second domain.

According to one or more example embodiments, provided is a method of performing a flush operation in a storage device that supports multiple namespaces, the flush operation method including: receiving a flush command from a host device; determining a data type field and a data information field of the flush command; selecting at least one piece of data to be moved from a volatile memory to a non-volatile memory device, based on the data type field and the data information field; and moving the selected at least one piece of data from the volatile memory to the non-volatile memory device in a unit smaller than or equal to a namespace.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a block diagram illustrating a storage system according to one or more example embodiments.

FIG. 2 is a block diagram illustrating an example of a controller according to one or more example embodiments.

FIG. 3 is a diagram illustrating an example of a flush command according to one or more example embodiments.

FIGS. 4A to 4D are diagrams illustrating examples of an operation of the storage system of FIG. 1.

FIG. 5 is a flowchart illustrating an example of the operation of the storage system of FIG. 1.

FIG. 6 is a block diagram illustrating a storage system according to one or more example embodiments.

FIGS. 7A to 7C are diagrams illustrating examples of an operation of the storage system of FIG. 6.

FIG. 8 is a block diagram illustrating a storage system according to one or more example embodiments.

FIG. 9 is a diagram illustrating an example of a host device, including a power loss protection (PLP) circuit, according to one or more example embodiments.

FIG. 10 is a block diagram illustrating a storage system according to one or more example embodiments.

FIG. 11 is a block diagram illustrating a data center to which the storage system according to one or more example embodiments is applied.

### DETAILED DESCRIPTION

Hereinafter, example embodiments will be described with reference to the accompanying drawings.

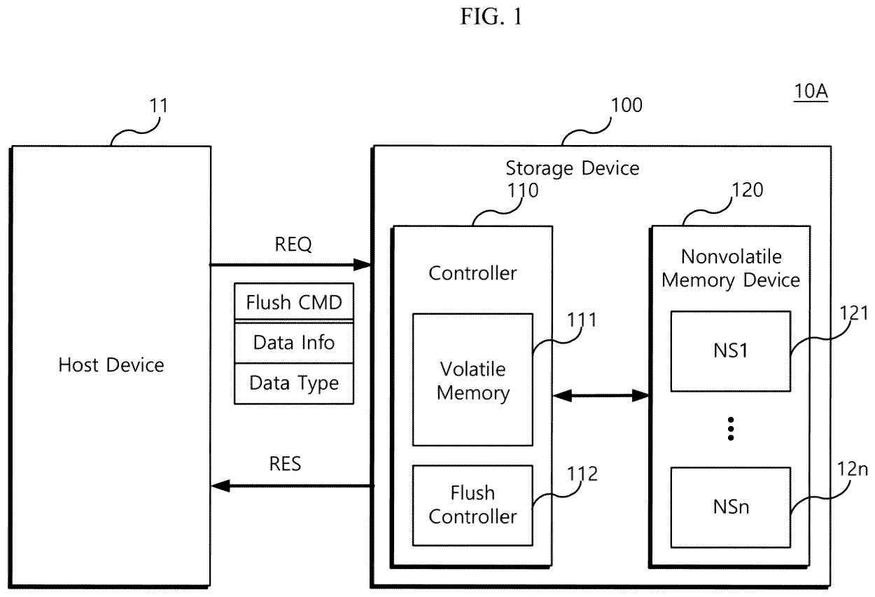

FIG. 1 is a block diagram illustrating a storage system 10A according to one or more example embodiments.

The storage system 10A may include a storage device 100. The storage device 100 according to one or more example embodiments may support a namespace function. The term ‘namespace function’ may refer to a function to provide a plurality of logical devices from a single physical device. For example, the namespace function may be a technique for dividing the storage device 100 into a plurality of namespaces and assigning unique logical addresses such as a logical block address (LBA) or a logical page number (LPN) for each namespace. The storage device 100 may manage the plurality of namespaces. Accordingly, the storage device 100 may be said to support a multiple namespace function.

In addition, the storage device 100 according to one or more example embodiments may support a flush function. The term ‘flush function’ may refer to a function of forcing a content, temporarily stored in a volatile memory of the storage device 100, to be non-volatile (or to move to a non-volatile memory).

For example, the storage device 100 according to one or more example embodiments may perform a flush operation to move data, stored in a volatile memory 111 of the storage device 100, to at least one of the plurality of namespaces of a non-volatile memory device 120 in response to a flush command Flush CMD from the host device. In this case, the storage device 100 may perform a flush operation in a unit smaller than or equal to a namespace. As described above, by performing a flush operation in a unit smaller than or equal to a namespace, the storage device 100 according to one or more example embodiments may provide a flush operation having improved performance.

Referring to FIG. 1, the storage system 10A may include the storage device 100 and a host device 11.

The storage system 10A may be implemented in various electronic devices. For example, the storage system 10A may be implemented in, for example but not limited to, a personal computer (PC), a data server, a network-attached storage (NAS), an Internet of Things (IoT) device, or a portable electronic device. The portable electronic device may include, for example but not limited to, a laptop computer, a mobile phone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, or the like.

The host device 11 may transmit various requests REQ to the storage device 100 and in response, receive a response RES through various interfaces. For example, the host device 11 may transmit a read command or a write command to the storage device 100. In addition, for example, the host device 11 may transmit the flush command Flush CMD to the storage device 100 to request an execution of a flush operation. In addition, for example, the host device 11 may transmit a namespace management command such as, for example, a namespace creation and/or deletion request to the storage device 100. In one or more example embodiments, the host device 11 may be an application processor (AP). In one or more example embodiments, the host device 11 may also be implemented as a system-on-a-chip (SoC).

The storage device 100 may be an internal memory embedded in an electronic device. For example, the storage device 100 may be a solid-state drive (SSD), an embedded universal flash storage (UFS) memory device, or an embedded multimedia card (eMMC). In one or more example embodiments, the storage device 100 may be a removable external memory for an electronic device. For example, the storage device 100 may be a UFS memory card, a compact flash (CF) card, a secure digital (SD) card, a micro secure digital (micro SD) card, a mini secure digital (mini SD) card, an extreme digital (xD) card or a memory stick.

The storage device 100 may include a controller 110 and a non-volatile memory device 120.

The controller 110 may read data stored in the non-volatile memory device 120 and/or write data in the non-volatile memory device 120 in response to a read and/or write request from the host device 11. In one or more example embodiments, the controller 110 may include a volatile memory 111 and a flush controller 112.

The volatile memory 111 may temporarily store data to be stored in the non-volatile memory device 120. For example, the volatile memory 111 may be implemented using a volatile memory such as a dynamic random access memory (DRAM) or a static random access memory (SRAM).

As illustrated in FIG. 1, the volatile memory 111 may be included in the controller 110. However, this is only an example, and example embodiments are not limited thereto. In example embodiments, the volatile memory 111 may be implemented independently of the controller 110.

The flush controller 112 may control the overall flush operation of the storage device 100 in response to the flush command Flush CMD. The ‘flush command Flush CMD’ may be a command used to request that a content in a volatile write cache in the storage device 100 be forced to be non-volatile. For example, in response to the flush command Flush CMD, the controller 110 may control the storage device 100 such that data stored in the volatile memory 111 is moved to at least one namespace, among namespaces NS1 121 to NSn 12n of the non-volatile memory device 120.

In one or more example embodiments, the flush controller 112 may control the storage device 100 such that the flush operation is performed in a unit smaller than or equal to a namespace. To this end, the flush command Flush CMD may include a data type field and a data information field.

The data type field may include information on a type of a data unit on which the flush operation is to be performed. For example, the data type field may include information on data type (or data unit type), which is a unit smaller than or equal to a namespace, such as a namespace, a stream, a zone, or a die, in performing the flush operation.

For example, a stream may refer to an independent input/output (I/O) unit for processing a request REQ from the host device 11.

For example, a zone may refer to a set of a fixed number of consecutive LBAs. In this case, a single zone may include a fixed number of consecutive LBAs, and a single namespace may include a plurality of zones.

For example, a die may refer to a set of a plurality of planes. In this case, a single plane may include a plurality of memory blocks, and a single die may include a plurality of planes.

However, this is only an example, and example embodiments are not limited thereto. According to example embodiments, the data type (or data unit type) may be defined in various ways.

The data information field may include information for selecting data on which the flush operation is to be performed. For example, the data information field may include data identification information such as a namespace identification (NSID), a stream ID, a zone ID, a die number, or the like.

The flush controller 112 may receive the flush command Flush CMD from the host device 11. Based on the data type field and the data information field of the flush command Flush CMD, the flush controller 112 may select data to be moved from the volatile memory 111 to the non-volatile memory device 120. Then, the flush controller 112 may perform a flush operation to move the selected data from the volatile memory 111 to at least one of the multiple namespaces 121 to 12n of the non-volatile memory device 120. In this case, the unit of the data type, on which the flush operation is performed, may be smaller than or equal to a namespace.

As illustrated in FIG. 1, the flush controller 112 may be included in the controller 110. However, this is only an example, and example embodiments are not limited thereto. In example embodiments, the flush controller 112 may also be implemented as a logic and/or a circuit independently of the controller 110.

Continuing to refer to FIG. 1, the non-volatile memory device 120 may include a memory cell array, and the memory cell array may include a plurality of memory cells.

In one or more example embodiments, the non-volatile memory device 120 may include a plurality of flash memory cells. For example, the plurality of flash memory cells may be NAND flash memory cells. However, example embodiments are not limited thereto, and the memory cells may be resistive memory cells such as resistive RAM (ReRAM) cells, phase change RAM (PRAM) cells, or magnetic RAM (MRAM) cells.

The non-volatile memory device 120 may include a plurality of namespaces NS1 121 to NSn 12n. A namespace may be defined as a quantity of a non-volatile memory that may be formatted with a logical address that the host may access. For example, a unique logical address such as LBA or LPN may be assigned to each of the plurality of namespaces 121 to 12n. For example, a namespace having a size n may be a collection of logical blocks having LBAs from 0 to (n−1). For example, a namespace having a size n may be a collection of logical pages having logic page numbers (LPNs) from 0 to (n−1). A logical address of each of the plurality of namespaces 121 to 12n may be mapped to a physical address of the non-volatile memory device 120. In one or more example embodiments, data temporarily stored in the volatile memory 111 may correspond to at least one of the plurality of namespaces 121 to 12n. When a flush operation is performed, the data temporarily stored in the volatile memory 111 may be moved to a corresponding namespace, among the plurality of namespaces 121 to 12n, in a unit smaller than or equal to a namespace. For example, when a flush operation is performed, the data temporarily stored in the volatile memory 111 may be stored in the memory cells of the physical address mapped to the logical address of the corresponding namespace.

As described above, the storage device 100 according to one or more example embodiments may support not only a multi-namespace function but also the flush function. When a flush operation is performed, the storage device 100 may move the data stored in the volatile memory 111 to a corresponding namespace, among the multiple namespaces 121 to 12n, in a unit smaller than or equal to a namespace. As described above, by performing a flush operation in a unit smaller than or equal to a namespace, the storage device 100 according to one or more example embodiments may provide a flush function having improved performance.

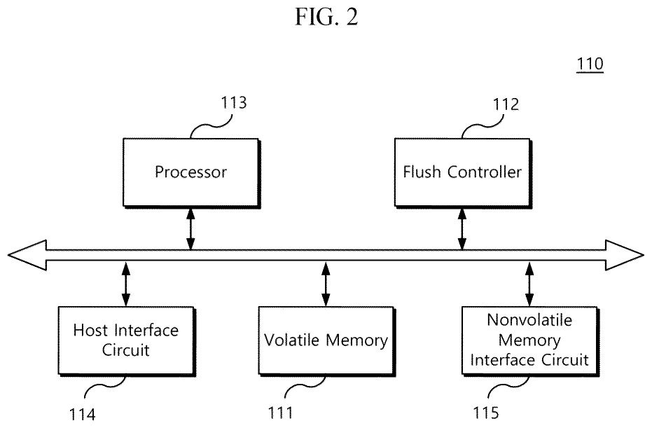

FIG. 2 is a block diagram illustrating an example of a controller according to one or more example embodiments. For example, a controller 110 of FIG. 2 may correspond to the controller 110 of FIG. 1.

Referring to FIG. 2, the controller 110 may include a volatile memory 111, a flush controller 112, a processor 113, a host interface circuit 114, and a non-volatile memory interface circuit 115.

The volatile memory 111 may be a memory device including volatile memory cells. For example, the volatile memory 111 may be one of various DRAM memory devices such as a double data rate (DDR) synchronous DRAM (SDRAM), a DDR2 SDRAM device, a DDR3 SDRAM device, a DDR4 SDRAM device, a DDR5 SDRAM device, a DDR6 SDRAM, a low power double data rate (LPDDR) SDRAM device, an LPDDR2 SDRAM device, an LPDDR3 SDRAM device, an LPDDR4 SDRAM device, an LPDDR4X SDRAM device, or an LPDDR5 SDRAM device. The memory device 11 may be a graphics DRAM device such as a graphics double data rate (GDDR) synchronous graphics random access memory (SGRAM) device, a GDDR2 SGRAM device, a GDDR3 SGRAM device, a GDDR4 SGRAM device, a GDDR5 SGRAM device, or a GDDR6 SGRAM device.

In one or more example embodiments, the volatile memory 111 may be a memory device in which DRAM dies are stacked, such as a high bandwidth memory (HBM), an HBM2, or an HBM3.

In one or more example embodiments, the volatile memory 111 may be a memory module such as a dual in-line memory module (DIMM). For example, the volatile memory 111 may be a registered DIMM (RDIMM), a load reduced DAIM (LRDIMM), an unbuffered DIMM (UDIMM), a fully buffered DIMM (FB-DIMM), and a small outline DIMM (SO-DIM). However, this is only an example, and the volatile memory 111 may be another memory module such as a single in-line memory module (SAIM).

In one or more example embodiments, the volatile memory 111 may be implemented using a volatile memory such as an SRAM.

The flush controller 112 may control the overall flush operation of the storage device 100 in response to the flush command Flush CMD received from the host device 11 (see FIG. 1).

For example, the flush controller 112 may select data to be moved from the volatile memory 111 to the non-volatile memory device 120 (see FIG. 1) from the data stored in the nonvolatile memory 111, based on the data type field and the data information field of the flush command Flush CMD. The flush controller 112 may move the selected data from the volatile memory 111 to at least one of the multiple namespaces 121 to 12n of the non-volatile memory device 120. In this case, a unit of the data type moved to the non-volatile memory device 120 may be smaller than or equal to a namespace.

The processor 113 may control the overall operation of the controller 110. For example, the processor 113 may execute various applications (for example, a flash translation layer (FTL) running on the controller 110).

In example embodiments, the processor 113 may be implemented to include the flush controller 112. In this case, the processor 113 may overall control the flush operation according to one or more example embodiments.

The host interface circuit 114 may communicate with a plurality of hosts 11 to In through a predetermined interface. For example, the predetermined interface may include at least one of various host interfaces such as a peripheral component interconnect express (PCI-express) interface, a non-volatile memory express (NVMe) interface, a serial ATA (SATA) interface, a serial attached SCSI (SAS) interface, and a universal flash storage (UFS) interface. For ease of description, an example will be provided in which the host interface circuit 114 is implemented based on an NVMe interface.

The non-volatile memory interface circuit 115 may provide a communication between the controller 110 and the non-volatile memory device 120. For example, when the non-volatile memory device 120 is a NAND flash memory device, the non-volatile memory interface circuit 115 may be a NAND interface.

As described above, the controller 110 according to one or more example embodiments may include the flush controller 112, and the flush controller 112 may move data, stored in the volatile memory 111, to the non-volatile memory device 120 in a unit smaller than or equal to a namespace. Accordingly, the performance of the flush operation may be improved.

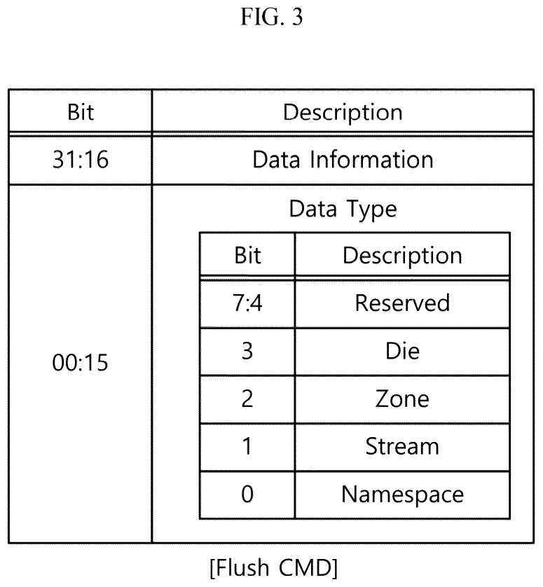

FIG. 3 is a diagram illustrating an example of a flush command Flush CMD according to one or more example embodiments.

Referring to FIG. 3, the flush command Flush CMD may include a data type field and a data information field. For ease of description, an example will be provided in which the flush command Flush CMD includes 32 bits. Also, an example will be provided in which each of the data type field and the data information field includes 16 bits. However, these are merely examples provided for description purposes and example embodiments are not limited thereto.

The data type field may include information on the type of data unit on which the flush operation is to be performed. The data type field may include information on data type having a unit smaller than or equal to a namespace, such as a namespace, a stream, a zone, or a die.

For example, when a bit value of the data type field is ‘0,’ a data management unit (or a unit of data in which the flush operation is to be performed) in the flush operation may be a namespace. Accordingly, data may be moved from volatile memory 111 (see FIG. 1) to the non-volatile memory device 120 in a unit of a namespace.

For example, when a bit value of the data type field is ‘1,’ the data management unit in the flush operation may be a stream. Accordingly, when the flush operation is performed, data may be moved from the volatile memory 111 to the non-volatile memory device 120 in a unit of a stream.

For example, when a bit value of the data type field is ‘2,’ the data management unit in the flush operation may be a zone. Accordingly, when the flush operation is performed, data may be moved from the volatile memory 111 to the non-volatile memory device 120 in a unit of a zone.

For example, when a bit value of the data type field is ‘3,’ the data management unit in the flush operation may be a die. Accordingly, when the flush operation is performed, data may be moved from the volatile memory 111 to the non-volatile memory device 120 in a unit of a die.

For example, bit values ‘4’ to ‘7’ of the data type field may be reserved as a spare area. Accordingly, various data units other than a namespace, a stream, a zone, and a die may be used as data management units in a flush operation.

The data information field may include information for selecting data on which a flush operation is to be performed.

For example, when a bit value of the data type field is ‘0,’ the data information field may include information on a namespace identification (NSID). Accordingly, among the data stored in the volatile memory 111 (see FIG. 1), data to be flushed may be specified in a unit of a namespace.

For example, when a bit value of the data type field is ‘1,’ the data information field may include information on a stream ID. Accordingly, among the data stored in the volatile memory 111, data to be flushed may be specified in a unit of a stream.

For example, when a bit value of the data type field is ‘2,’ the data information field may include information on a zone ID. Accordingly, among the data stored in the volatile memory 111, data to be flushed may be specified in a unit of a zone.

For example, when a bit value of the data type field is ‘3,’ the data information field may include information on a die ID (or die number). Accordingly, among the data stored in the volatile memory 111, the data to be flushed may be specified in a unit of a die.

As described above, the flush operation according to one or more example embodiments may support various data units other than a namespace in which the flush operation is to be performed. Thus, the flush operation may be efficiently performed.

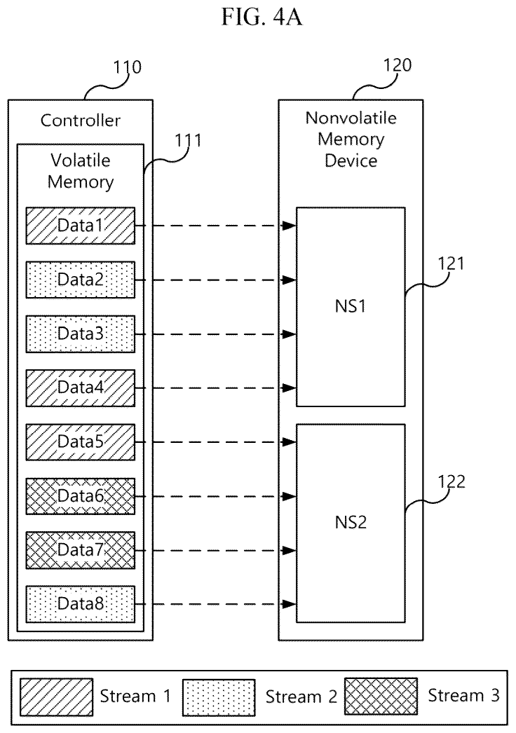

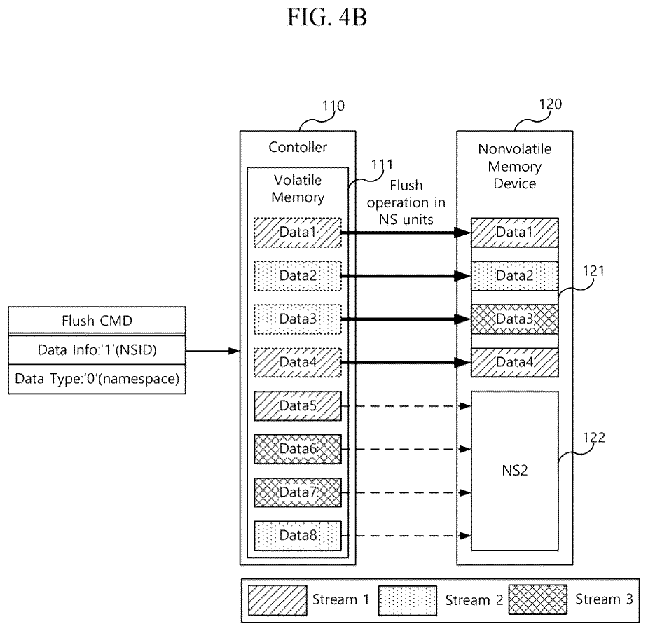

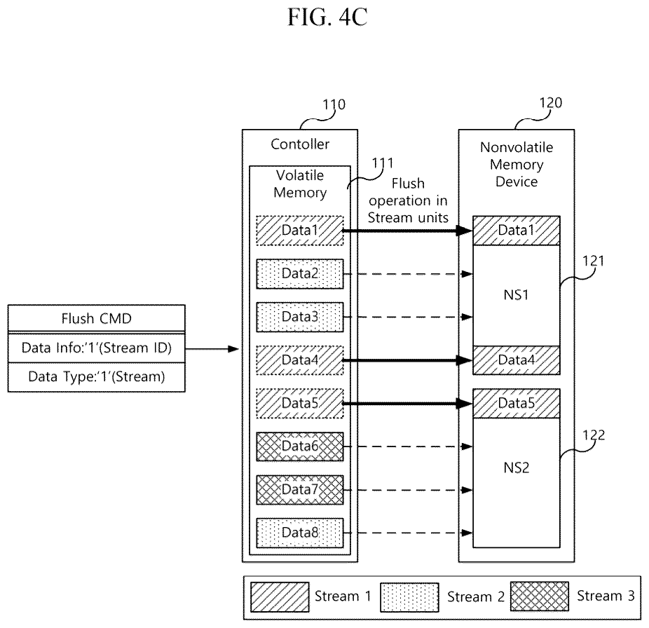

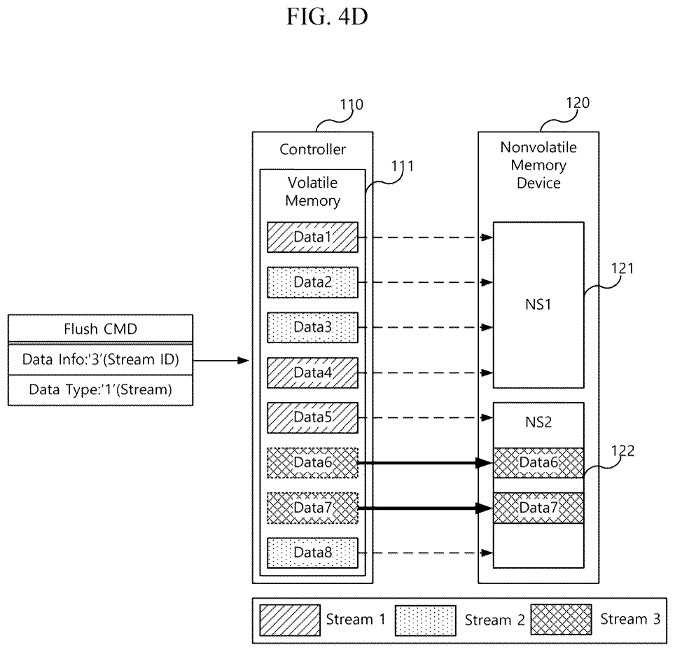

FIGS. 4A to 4D are diagrams illustrating examples of an operation of the storage system 10A of FIG. 1. FIG. 4A illustrates an example of data stored in the volatile memory 111 before receiving the flush command Flush CMD. FIG. 4B illustrates an example of a flush operation performed in a unit of a namespace. FIG. 4C illustrates an example of a flush operation performed in a unit of a stream, and FIG. 4D illustrates another example of a flush operation performed in a unit of a stream.

For ease of description, an example will be provided in which the non-volatile memory device 120 includes a first namespace 121 and a second namespace 122. An example will be provided in which the volatile memory 111 temporarily stores first to eighth data Data1 to Data8. Also, an example will be provided in which the flush operation is performed either in a unit of a namespace or a unit of a stream.

Referring to FIG. 4A, logical addresses of the first data Data1 to the fourth data Data4 stored in the volatile memory 111 may correspond to the first namespace 121, and logical addresses of the fifth data Data5 to the eighth data Data8 may correspond to the second namespace 122. Accordingly, when a flush operation or a write operation is performed, the first data Data1 to the fourth data Data4 stored in the volatile memory 111 may be stored in the memory cells corresponding to the first namespace 121, and the fifth data Data5 to the eighth data Data8 may be stored in the memory cells corresponding to the second namespace 122.

In addition, an example will be provided in which the first data Data1, the fourth data Data4, and the fifth data Data5 stored in the volatile memory 111 are included in a first stream Stream1, the second data Data2, the third data Data3, and the eighth data Data8 are included in a second stream Stream2, and the sixth data Data6 and the seventh data Data7 are included in a third stream Stream3.

Referring to FIG. 4B, the controller 110 may receive a flush command Flush CMD from the host device 11 requesting that a flush operation be performed in a unit of a namespace.

For example, a bit value of the data type field may be ‘0.’ Accordingly, the flush operation may be performed in a unit of a namespace. Also, an NSID value of the data information field may be ‘1.’ Accordingly, data corresponding to the first namespace 121 may be selected from among the data stored in the volatile memory 111. For example, the first data Data1 to the fourth data Data4 may be selected from among the data stored in the volatile memory 111.

Then, when the flush operation is performed, the first data Data1 to the fourth data Data4 stored in the volatile memory 111 may be moved to the non-volatile memory device 120.

As described above, the storage system 10A according to one or more example embodiments may perform a flush operation in a unit of a namespace.

Referring to FIG. 4C, the controller 110 may receive a flush command Flush CMD from the host device 11 requesting that a flush operation be performed in a unit of a stream.

For example, a bit value of the data type field may be ‘1’. Accordingly, the flush operation may be performed in a unit of a stream. In addition, a stream ID value of the data information field may be ‘1.’ Accordingly, data corresponding to a first stream Stream1 may be selected from among the data stored in the volatile memory 111. For example, the first data Data1, the fourth data Data4, and the fifth data Data5 may be selected from among the data stored in the volatile memory 111.

Then, when the flush operation is performed, the first data Data1, the fourth data Data4, and the fifth data Data5 stored in the volatile memory 111 may be moved to the non-volatile memory device 120. For example, the first data Data1 and the fourth data Data4 may be stored in non-volatile memory cells of a logical address corresponding to the first namespace NS1, and the fifth data Data5 may be stored in non-volatile memory cells of a logical address corresponding to the second namespace NS2.

When the flush operation is performed only in a unit of a namespace, the flush operation may be inefficient. For example, when a plurality of pieces of data belonging to the first stream Stream1 are important data or there is a risk of data loss caused by sudden power-off (SPO), the host 11 may request that the plurality of pieces of data belonging to the first stream Stream1 be rapidly flushed to the non-volatile memory device 120. However, when the flush operation is performed only in a unit of a namespace, the flush operation should be performed on both the first namespace 121 and the second namespace 122 to flush the data belonging to the first stream Stream1. For example, the larger a size of a namespace, the greater the amount of time required for the flush operation. Accordingly, the flush operation may not be completed within the time desired by the host device 11.

In contrast, the storage system 10A according to one or more example embodiments may perform a flush operation in a unit smaller than a namespace, for example, in a unit of a stream. In this case, a plurality of pieces of data belonging to a stream requested by the host are selected and the flush operation is performed on the selected data, so that the flush operation may be efficiently performed.

In the example of FIG. 4C, the plurality of pieces of data Data1, Data4, Data5, belonging to the first stream Stream1, may be distributed to and stored in the first and second namespaces 121 and 122. However, this is only an example, and example embodiments are not limited thereto, and a plurality of pieces of data belonging to a specific stream may also be stored in the same namespace, or stored in three or more namespaces.

Another example will be described with reference to FIG. 4D. The controller 110 may receive a flush command Flush CMD from the host device 11 requesting that a flush operation be performed in a unit of a stream.

For example, a bit value of the data type field may be ‘1.’ Accordingly, the flush operation may be performed in a unit of a stream. Also, the stream ID value of the data information field may be ‘3.’ Accordingly, the data corresponding to the third stream Stream3 may be selected from among the data stored in the volatile memory 111. For example, the sixth data Data6 and the seventh data Data7 included in the third stream Stream3 may be selected from among the data stored in the volatile memory 111.

Then, when the flush operation is performed, the sixth data Data6 and the seventh data Data7 stored in the volatile memory 111 may be stored in non-volatile memory cells of a logical address corresponding to the second namespace NS2 of the non-volatile memory device 120.

As described above, the storage system 10A according to one or more example embodiments may perform a flush operation in a unit smaller than a namespace, for example, in a unit of a stream. In this case, data belonging to the stream requested by the host may be distributed to and stored in different namespaces, or may be stored in the same namespace.

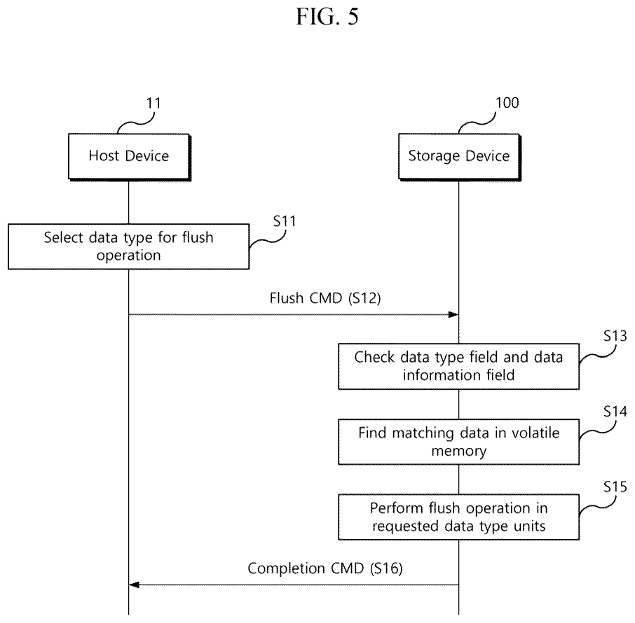

FIG. 5 is a flowchart illustrating an example of an operation of the storage system 10A of FIG. 1.

In operation S11, the host device 11 may select a data type, indicating a data unit, on which the flush operation is to be performed. For example, the host device 11 may select one of units that is smaller than or equal to a namespace, such as a namespace, a stream, a zone, or a die, as a data unit on which the flush operation is to be performed.

In operation S12, the flush command Flush CMD may be transmitted from the host device 11 to the storage device 100. For example, the flush command Flush CMD may include a data type field and a data information field. The data type field may include information on the type of data unit on which the flush operation is to be performed, such as a data unit of a namespace, a stream, a zone, or a die. The data information field may include information (e.g., identification information) for selecting data on which the flush operation is to be performed.

In operation S13, the storage device 100 may check the data type field and the data information field of the flush command Flush CMD.

In operation S14, the storage device 100 may find data in the volatile memory that matches information in the data type field and the data information field of the flush command Flush CMD. For example, the storage device 100 may select data to be moved from the volatile memory to the non-volatile memory device, based on the data type field and the data information field of the flush command Flush CMD.

In operation S15, the storage device 100 may perform the flush operation based on the data type (or data unit type) requested by the host device 11. For example, the storage device 100 may move the data, stored in the volatile memory that has been determined to match the information in the data type field and the data information field of the flush command Flush CMD, to the non-volatile memory device. In this case, a unit of the type of the data on which the flush operation is performed may be smaller than or equal to a namespace.

In operation S16, the storage device 100 may transmit a completion command Completion CMD, indicating that the flush operation has been completed, to the host device 11.

As described above, the storage system 10A according to one or more example embodiments may perform a flush operation in a unit smaller than or equal to a namespace. Thus, the flush operation may be efficiently performed.

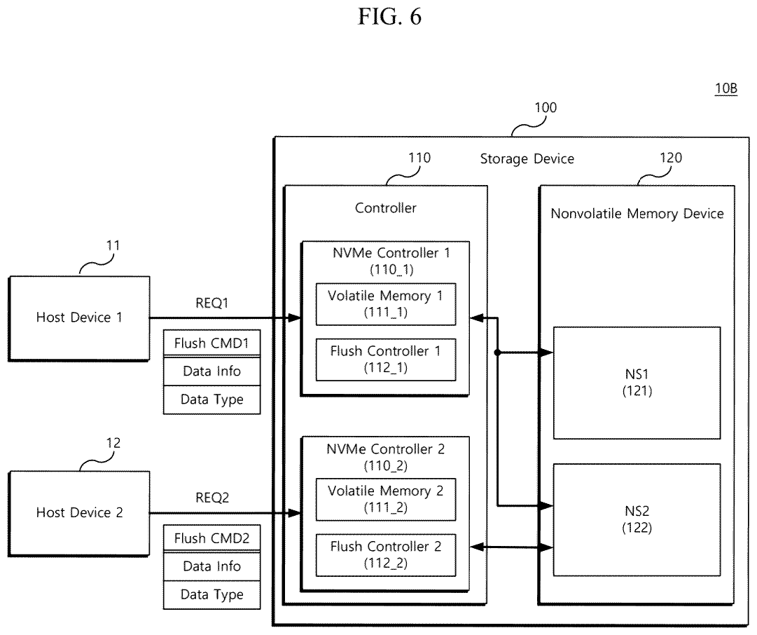

FIG. 6 is a block diagram illustrating a storage system 10B according to one or more example embodiments. The storage system 10B of FIG. 6 may be similar to the storage system 10A described in FIGS. 1 to 5. Therefore, the same or similar components will be denoted by the same or similar reference numerals, and duplicate descriptions will be omitted below.

In FIG. 6, for ease of description, an example will be provided in which the storage system 10B includes a first host device 11 and a second host device 12, and an interface between the host devices 11 and 12 and a storage device 100 is implemented based on an NVMe interface. An example will also be provided in which the non-volatile memory device 120 includes a first namespace 121 and a second namespace 122.

The storage system 10B according to one or more example embodiments may be implemented to support multiple hosts and/or multiple tenants. In this case, the flush operation may be performed in a unit smaller than or equal to a namespace. Accordingly, a flash operation having improved performance may be provided.

The storage system 10B according to one or more example embodiments may include a plurality of host devices 11 and 12, and may include a storage device 100 corresponding to the plurality of host devices 11 and 12. For example, the storage device 100 may be a storage device configured to support multiple hosts and/or multiple tenants.

The storage device 100 may communicate with each of the first and second host devices 11 and 12 via a physical layer based on an NVMe interface or a PCIexpress interface. The storage device 100 may include a controller 110 and a non-volatile memory device 120, and the controller 110 may include a first controller NVMe controller 110_1 and a second NVMe controller 110_2.

The first and second NVMe controllers 110_1 and 110_2 may each be implemented based on the NVMe interface and may process information received from the first and second hosts 11 and 12. For example, each of the first and second NVMe controllers 111 and 112 may be implemented in the form of software, hardware, and/or a combination thereof, based on the NVMe interface. In one or more example embodiments, the first and second NVMe controllers 110_1 and 110_2, respectively corresponding to the first and second hosts 11 and 12, may also be referred to as first and second physical functions, respectively.

The first NVMe controller 110_1 may include a first volatile memory 111_1 and a first flush controller 112_1.

The first volatile memory 111_1 may temporarily store data requested to be written from the first host device 11. The first flush controller 112_1 may receive a first flush command Flush CMD1 from the first host device 11 and perform a flush operation based on the first flush command Flush CMD1 to move selected data, stored in the first volatile memory 111_1, to at least one of the first and second namespaces 121 and 122 of the non-volatile memory device 120. In this case, a unit of the type of data unit on which the flush operation is performed may be smaller than or equal to a namespace.

Similarly, the second NVMe controller 110_2 may include a second volatile memory 111_2 and a second flush controller 112_2.

The second volatile memory 111_2 may temporarily store data requested to be written from the second host device 12. The second flush controller 112_2 may receive a second flush command Flush CMD2 from the second host device 12 and perform a flush operation to move selected data, stored in the second volatile memory 111_2, to at least one of the first and second namespaces 121 and 122 of the non-volatile memory device 120, based on the second flush command Flush CMD2. In this case, a unit of the type of data unit on which the flush operation is performed may be smaller than or equal to a namespace.

In the example of FIG. 6, the first and second NVMe controllers 110_1 and 110_2 may be implemented in the form of hardware, and thus each of the first and second NVMe controllers 110_1 and 110_2 may include a volatile memory. However, this is only an example, and the first and second NVMe controllers 110_1 and 110_2 may be implemented in the form of software according to example embodiments. In this case, the first and second volatile memories 111_1 and 111_2 may be implemented independently of the first and second NVMe controllers 110_1 and 110_2.

The non-volatile memory device 120 may include a plurality of namespaces, and at least one of the plurality of namespaces may be shared by the NVMe controllers 110_1 and 110_2. For example, as illustrated in FIG. 6, the non-volatile memory device 120 may include the first and second namespace 121 and 122, and the first namespace 121 may correspond to the first NVMe controller 110_1 and the second namespace 122 may correspond to the first and second NVMe controllers 110_1 and 110_2. For example, the second namespace 122 may be shared by the first and second NVMe controllers 110_1 and 110_2.

As described above, the storage device 100 according to one or more example embodiments may be a storage device configured to support multiple hosts and/or multiple tenants. In this case, the storage device 100 may perform a flush operation in a unit smaller than or equal to a namespace. Thus, a flush function having improved performance may be provided.

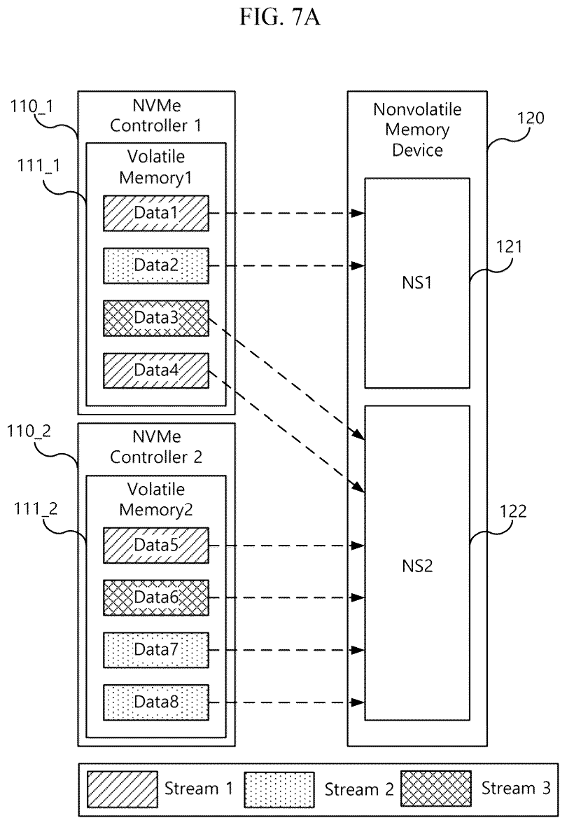

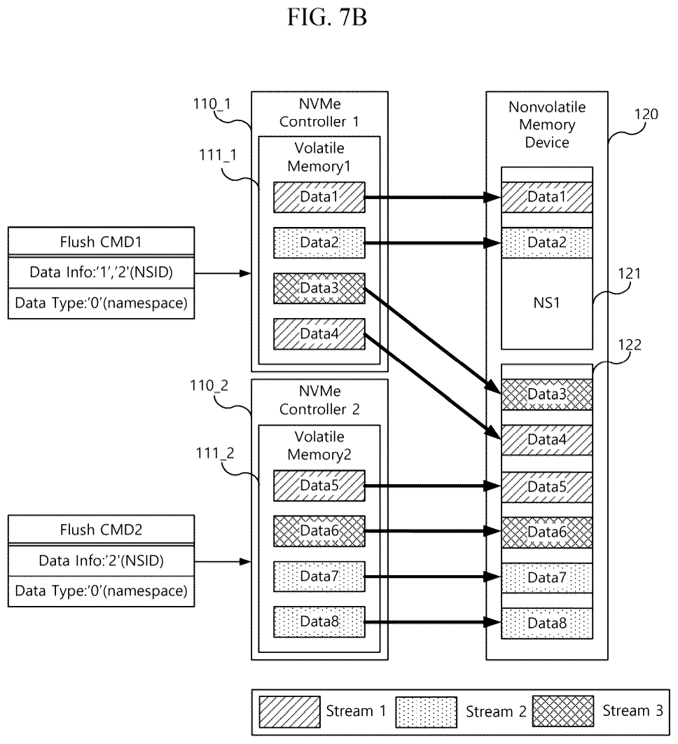

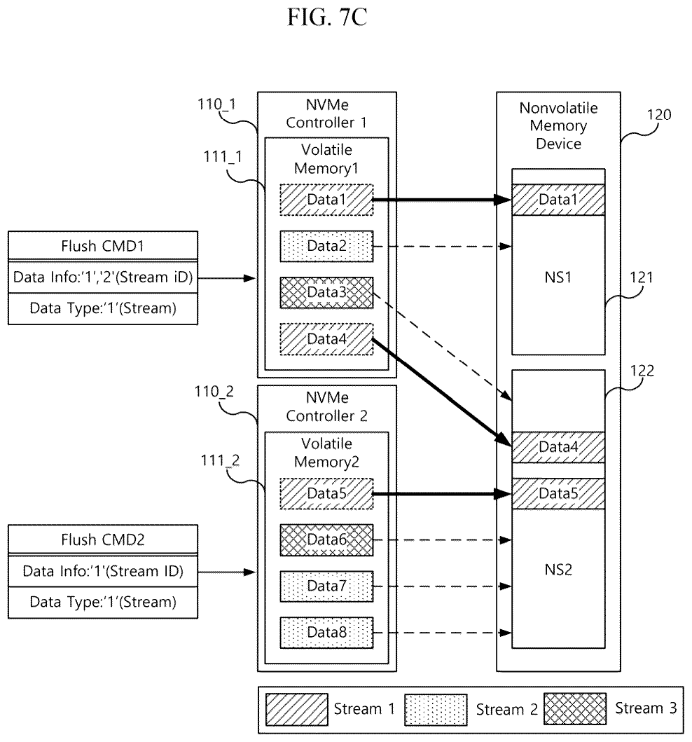

FIGS. 7A to 7C are diagrams illustrating examples of an operation of the storage system 10B of FIG. 6. FIG. 7A illustrates an example of the data stored in the first and second volatile memories 111_1 and 111_2 before receiving a flush command Flush CMD. FIG. 7B illustrates an example of a flush operation performed in a unit of a namespace. FIG. 7C illustrates an example of a flush operation performed in a unit of a stream.

For ease of description, an example will be provided in which the first volatile memory 111_1 temporarily stores the first data Data1 to the fourth data Data4, and the second volatile memory 111_2 temporarily stores the fifth data Data5 to the eighth data Data8. An example will also be provided in which the first NVMe controller 110_1 and the second NVMe controller 110_2 share the second namespace 122.

Referring to FIG. 7A, logical addresses of the first data Data1 and the second data Data2 stored in the first volatile memory 111_1 may correspond to the first namespace 121, and logical addresses of the third data Data3 and the fourth data Data4 may correspond to the second namespace 122.

Accordingly, when a flush operation or a write operation is performed, the first data Data1 and the second data Data2 stored in the first volatile memory 111 may be stored in memory cells corresponding to the first namespace 121, and the third data Data3 and the fourth data Data4 stored in the first volatile memory 111 may be stored in memory cells corresponding to the second namespace 122.

Also, logical addresses of the fifth data to the eighth data Data5 to Data8 of the second volatile memory 111_2 may correspond to the second namespace 122.

Accordingly, when a flush operation or a write operation is performed, the fifth data to the eighth data Data5 to Data8 of the second volatile memory 111_2 may be stored in memory cells corresponding to the second namespace 122.

An example will be provided in which the first data, the fourth data, and the fifth data Data1, Data4, and Data5 may be included in the first stream Stream1, the second, the seventh data, and the eighth data Data2, Data7, and Data8 may be included in the second stream Stream2, and the third data and the sixth data Data3 and Data6 may be included in the third stream Stream3.

In FIGS. 7B and 7C below, for ease of description, an example will be provided in which a plurality of pieces of data belonging to the first stream Stream1 (that is, the first data Data1, the fourth data Data4, and the fifth data Data5) are important data or there is a risk of data loss caused by sudden power-off (SPO). Therefore, an example will be provided in which a flush operation is requested for the data Data1, Data4, and Data5 belonging to the first stream Stream1.

FIG. 7B illustrates an example in which the storage system 10B performs a flush operation in a unit of a namespace.

To perform a flush operation on the data Data1, Data4, and Data5 belonging to the first stream Stream1, the first host device 11 may transmit a first flush command Flush CMD1 to the first NVMe controller 110_1 and the second host device 12 may transmit a second flush command Flush CMD2 to the second NVMe controller 110_2.

The flush operation corresponding to the first flush command Flush CMD1 may be performed in a unit of a namespace, such that a bit value of the data type field of the first flush command Flush CMD1 may be ‘0.’ Also, the first data Data1 and the fourth data Data4 belonging to the first stream Stream1 correspond to the first and second namespaces 121 and 122, respectively, such that an NSID value of the data information field of the first flush command Flush CMD1 may include ‘1’ and ‘2.’

Similarly, the flush operation corresponding to the second flush command Flush CMD2 may be performed in a unit of a namespace, such that a bit value of the data type field of the second flush command Flush CMD2 may be ‘0.’ Also, the fifth data Data5 belonging to the first stream Stream1 corresponds to the second namespace 122, such that an NSID value of the data information field of the second flush command Flush CMD2 may be ‘2.’

The first and second NVMe controllers 110_1 and 110_2 may perform a flush operation in response to the first and second flush commands Flush CMD1 and Flush CMD2, respectively. As a result, in addition to the data Data1, Data4, and Data5 belonging to the first stream Stream1, data belonging to the second and third streams Stream2 and Stream3 may also be flushed to the first and second namespaces 121 and 122, as illustrated in FIG. 7B.

FIG. 7C illustrates an example in which the storage system 10B performs a flush operation in a unit of a stream.

The flush operation corresponding to the first flush command Flush CMD1 may be performed in a unit of a stream, such that a bit value of the data type field of the first flush command Flush CMD1 may be ‘1.’ Also, the first data Data1 and the fourth data Data4 belonging to the first stream Stream1 correspond to the first and second namespaces 121 and 122, respectively, such that a stream ID value of the data information field of the first flush command Flush CMD1 may include ‘1’ and ‘2.’

Similarly, the flush operation corresponding to the second flush command Flush CMD2 may be performed in a unit of a stream, such that a bit value of the data type field of the second flush command Flush CMD2 may be ‘1.’ Also, the fifth data Data5 belonging to the first stream Stream1 corresponds to the second namespace 122, such that a stream ID value of the data information field of the second flush command Flush CMD2 may be ‘2.’

As a result, the data Data1, Data4, and Data5 belonging to the first stream Stream1 may be flushed to the first and second namespaces 121 and 122, as illustrated in FIG. 7C.

As described above, even when multiple hosts and/or multiple tenants are supported, the storage device 100 according to one or more example embodiments may perform a flush operation on the data stored in the volatile memory in a unit smaller than or equal to a namespace. Thus, the storage device 100 according to one or more example embodiments may provide a flush function having improved performance.

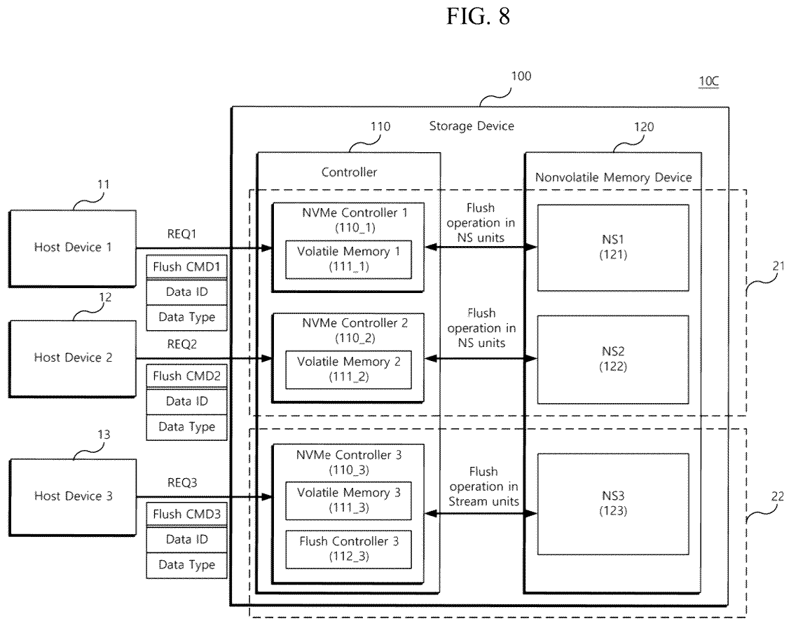

FIG. 8 is a block diagram illustrating a storage system 10C according to one or more example embodiments. The storage system 10C of FIG. 8 may be similar to the storage systems 10A and 10B described in FIGS. 1 to 7. Therefore, the same or similar components will be denoted by the same or similar reference numerals, and redundant descriptions will be omitted below.

In FIG. 8, for ease of description, an example will be provided in which the storage system 10B includes first to third host devices 11, 12, and 13, and an interface between the first to third host devices 11, 12, and 13 and the storage device 100 is implemented based on an NVMe interface. Also, an example will be provided in which the controller 110 includes first to third NVMe controllers 110_1 to 110_3, and the non-volatile memory device 120 includes first to third namespaces 121 to 123.

The storage system 10C according to one or more example embodiments may be implemented to support multiple domains. The domain may be a smallest indivisible unit sharing a power state, a state of capacity information, or the like. Even in this case, the flush operation may be performed in a unit smaller than or equal to a namespace. Accordingly, a flush operation having improved performance may be provided. In addition, a flush operation may be performed in a unit smaller than or equal to a namespace on domains other than domains protected by a power loss protection (PLP) circuit. As a result, data may be protected more stably.

The storage system 10C according to one or more example embodiments may include first to third host devices 11 to 13 and may include a storage device 100 corresponding to the first to third host devices 11 to 13.

The storage device 100 may include a controller 110 and a non-volatile memory device 120. The controller 110 may include first to third NVMe controllers 110_1 to 110_3, and the non-volatile memory device 120 may include first to third namespaces 121 to 123.

The first and second NVMe controllers 110_1 and 110_2 and the first and second namespaces 121 and 122 may be included in a first domain 21. The third NVMe controller 110_3 and the third namespace 123 may be included in a second domain 22. The first domain 21 and the second domain 22 may have different states.

In one or more example embodiments, the first domain 21 may include a PLP circuit. Accordingly, the data stored in the first and second volatile memories 111_1 and 111_2 of the first domain 21 may be protected by the PLP circuit even in an SPO situation.

In this case, time sufficient to flush data, stored in the first and second volatile memories 111_1 and 111_2, to the non-volatile memory device 120 may be secured even in an SPO situation. Therefore, as illustrated in FIG. 8, the data stored in the first and second volatile memories 111_1 and 111_2 of the first domain 21 may be flushed in a unit of a namespace. However, this is only an example, and the data stored in the first and second volatile memories 111_1 and 111_2 of the first domain 21 may be flushed in a unit smaller than a namespace.

In one or more example embodiments, the second domain 22 may not include a PLP circuit. Accordingly, the data stored in the third volatile memory 111_3 of the second domain 22 is at a relatively high risk of being lost in an SPO situation.

The third host 13 may transmit a flush command Flush CMD3, requesting a flush operation to be performed at a relatively short interval, to the third NVMe controller 110_3 to improve data stability of the data stored in the third volatile memory 111_3 of the second domain 22. As described above, the flush command Flush CMD3 may include a data type field and a data information field. While FIG. 8 shows that the first host device 11 and the second host device 12 may respectively transmit a flush command Flush CMD1 and a flush command Flush CMD2, each including the data type field and the data information field, this is only an example, and the flush commands Flush CMD1 and Flush CMD2 may not include the data type field and the data information field.

The third NVMe controller 110_3 may move data, stored in the third volatile memory 111_3, to the non-volatile memory device 120 in response to the flush command Flush CMD3. In this case, as illustrated in FIG. 8, the data stored in the third volatile memory 111_3 of the second domain 22 may be flushed in a unit smaller than a namespace for example, in a unit of a stream, a zone, or a die. Accordingly, the flush operation may be performed faster than when the flush operation is performed in a unit of a namespace.

As a result, the flush operation may be performed rapidly in a short time period, and a plurality of pieces of data in the second domain 22 that is not protected by the PLP circuit may also be stored safely in a short time period.

As described above, even when multiple domains are supported, the storage device 100 according to one or more example embodiments may perform a flush operation on the data stored in the volatile memory in a unit smaller than or equal to a namespace. Accordingly, a flush function having improved performance may be provided, and data may be protected more safely.

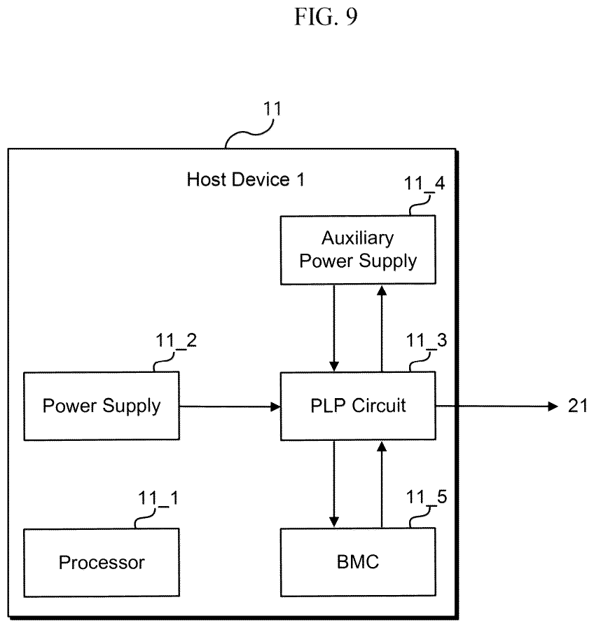

FIG. 9 is a diagram illustrating an example of a host device according to one or more example embodiments that includes a PLP circuit. The host device of FIG. 9 may correspond to either the first host device 11 or the second host device 12 of FIG. 8. FIG. 9 illustrates, for example, the first host device 11 of FIG. 8, but the same descriptions may apply for the second host device 12 of FIG. 8.

Referring to FIG. 9, the host device 11 according to one or more example embodiments may supply power to the storage device 100 (see FIG. 8). The host device 11 may include a processor 11_1, a power supply 11_2, a PLP circuit 11_3, an auxiliary power supply 11_4, and a baseboard management controller (BMC) 11_5.

The processor 11_1 may control the overall operation of the host device 11.

The power supply 11_2 may supply power to the storage system. For example, the power supply 11_2 may supply power to the storage device 100. For example, the power supply 11_2 may also supply main power to the PLP circuit 11_3.

The PLP circuit 11_3 may manage the power supply to the first domain 21 (see FIG. 8). For example, the PLP circuit 11_3 may supply the main power supplied from the power supply 11_2 to the first NVMe controller 110_1 (see FIG. 8) included in the first domain 21. Also, the PLP circuit 11_3 may supply the main power supplied from the power supply 11_2 to the auxiliary power supply 11_4.

The auxiliary power supply 11_4 may receive power from the PLP circuit 11_3 to be charged. For example, the auxiliary power supply 11_4 may include a capacitor, a super capacitor, and/or a rechargeable battery.

The baseboard management controller 11_5 may monitor a status of the storage system 10C (see FIG. 8) and perform a power management operation for the storage device 100.

When an SPO occurs, the host device 1 may supply power to at least one of the first and second NMVe controllers 110_1 and 110_2, included in the first domain 21, using the PLP circuit 11_3 and/or the auxiliary power supply 11_4. Accordingly, data temporarily stored in the first and second volatile memories 111_1 and 111_2 (see FIG. 8) may be safely transmitted to the non-volatile memory device 120. As a result, the data temporarily stored in the volatile memory 111_1 and 111_2 of the first domain 21 may be safely protected.

The volatile memory 111_3 of the second domain 22 (see FIG. 8) that is not protected by the PLP circuit may be subjected to a flush operation in data a unit smaller than a namespace. Accordingly, the flush operation may be performed more rapidly. Also, a flush period for the volatile memory 111_3 of the second domain 22 that is not protected by the PLP circuit may be shorter than that of the first domain 21. As a result, the flush operation may be performed more rapidly at a shorter time period to protect the data of the second domain 22 more safely.

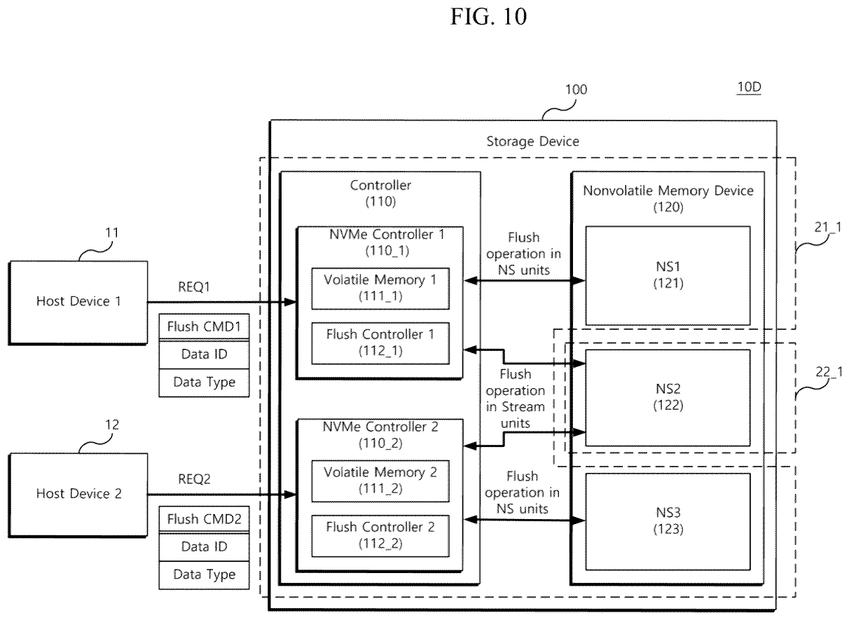

FIG. 10 is a block diagram illustrating a storage system 10D according to one or more example embodiments. The storage system 10D of FIG. 10 may be similar to the storage system 10C of FIG. 8. Therefore, the same or similar components will be denoted by the same or similar reference numerals, and redundant descriptions will be omitted below.

In the storage system 10C of FIG. 8, an example is provided in which the first domain 21 includes the first and second NVMe controllers 110_1 and 110_2 and the first and second namespaces 121 and 122, and the second domain 22 includes the third NVMe controller 110_3 and the third namespace 123. However, this is only an example, and example embodiments are not limited thereto. According to one or more example embodiments, a domain may be set in various ways. For example, a domain may be set to include only a namespace.

Referring to FIG. 10, in the storage system 10D, the second namespace 122 may be shared by the first and second NVMe controllers 110_1 and 110_2.

In the example of FIG. 10, a first domain 21_1 may be set to include the first and second NVMe controllers 110_1 and 110_2 and the first and second namespaces 121 and 122. a second domain 22_1 may be set to the third namespace 123.

In one or more example embodiments, the first domain 21_1 may be protected by a PLP circuit. In this case, the flush operation corresponding to the first domain 21_1 may be performed in a unit of a namespace. For example, a flush operation from the first volatile memory 111_1 to the first namespace 121 and/or a flush operation from the second volatile memory 111_2 to the third namespace 123 may be performed in a unit of a namespace.

In one or more example embodiments, the second domain 21_2 may not be protected by a PLP circuit. In this case, a flush operation corresponding to the second domain 21_2 may be performed in data a unit smaller than a namespace, for example, in a unit of a stream. For example, a flush operation from the first volatile memory 111_1 to the second namespace 122 and/or a flush operation from the second volatile memory 111_2 to the second namespace 122 may be performed in data a unit smaller than a namespace.

As described above, the storage system 10D according to one or more example embodiments may support multiple domains, and each domain may be set in various ways. Even in this case, the storage device 100 according to one or more example embodiments may perform a flush operation in a unit smaller than or equal to a namespace. Thus, a flush function having improved performance may be provided, and data may be protected more safely.

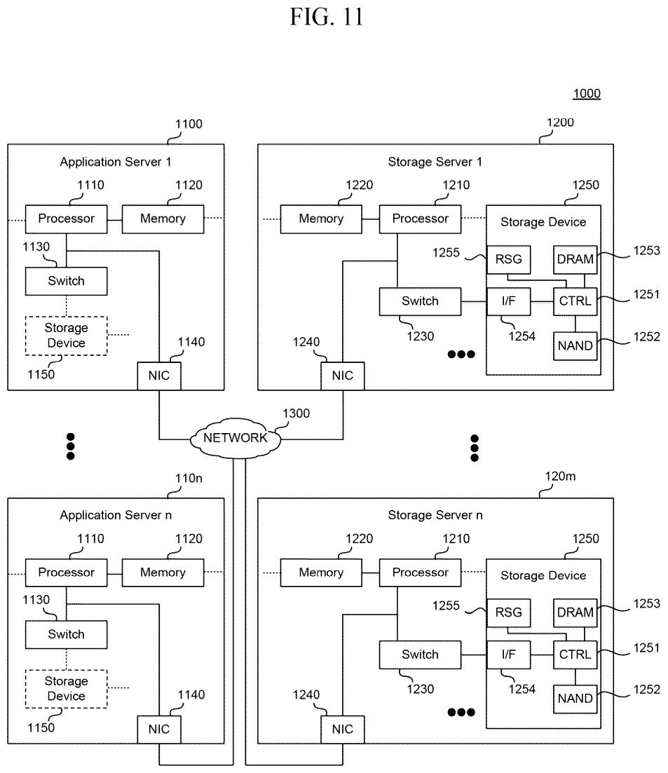

FIG. 11 is a block diagram illustrating a data center to which a storage system according to one or more example embodiments is applied.

Referring to FIG. 11, a data center 1000 may be a facility collecting various types of data and providing services, and may also be referred to as a data storage center. The data center 1000 may be a system for operating search engines and databases, or a computing system used by a company or a government institution such as bank.

The data center 1000 may include server devices 1100 to 1100n implemented as application servers 1100 to 1100n, and may include server devices 1200 to 1200m implemented as storage servers 1200 to 1200m. The number of application servers 1100 to 1100n and the number of storage servers 1200 to 1200m may vary according to example embodiments, and the number of application servers 1100 to 1100n may be different from the number of storage servers 1200 to 1200m.

The application server 1100 and/or the storage server 1200 may include at least one of processors 1110 and 1210 and memories 1120 and 1220. The storage server 1200 will now be described as an example. The processor 1210 may control the overall operation of the storage server 1200, and access the memory 1220 to execute instructions and/or data loaded in the memory 1220.

The memory 1220 may include at least one of a double data rate synchronous DRAM (DDR SDRAM), a high bandwidth memory (HBM), a hybrid memory cube (HMC), a dual in-line memory module (DIM), an Optane DIMM, or a non-volatile DIMM (NVMDIMM).

The number of processors 1210 included in the storage server 1200 and the number of memories 1220 included in the storage server 1200 may vary according to example embodiments. In one or more example embodiments, the processor 1210 and the memory 1220 may provide a processor-memory pair. In one or more example embodiments, the number of memories 1220 and the number of memories 1220 may be different from each other. The processor 1210 may include a single-core processor or a multi-core processor. The above descriptions of the storage server 1200 may be similarly applied to the application server 1100. According to one or more example embodiments, the application server 1100 may not include a storage device 1150. The storage server 1200 may include at least one storage device 1250. The number of the storage devices 1250 included in the storage server 1200 may be variously selected according to example embodiments.

The application servers 1100 to 1100n and the storage servers 1200 to 1200m may communicate with each other over a network 1300. The network 1300 may be implemented using Fiber Channel (FC) or Ethernet. In this case, FC may be a medium used for relatively high-speed data transmission, and may employ an optical switch providing high performance and/or high availability. The storage servers 1200 to 1200m may be provided as a file storage, a block storage, or an object storage depending on an access scheme of the network 1300.

In one or more example embodiments, the network 1300 may be implemented as a storage dedicated network such as a storage area network (SAN). For example, the SAN may be an FC-SAN that uses an FC network and is implemented based on an FC protocol (FCP). In an example, the SAN may be an IP-SAN that uses a TCP/IP network and is implemented based on an SCSI over TCP/IP (iSCSI or Internet SCSI) protocol. In one or more example embodiments, the network 1300 may be a general network such as a TCP/IP network. For example, the network 1300 may be implemented based on a protocol such as FC over Ethernet (FCoE), Network Attached Storage (NAS), and NVMe over Fabrics (NVMe-oF).

Hereinafter, descriptions will be focused on the application server 1100 and the storage server 1200. The descriptions of the application server 1100 may be equally applied to other application servers 1100n, and the descriptions of the storage server 1200 may be equally applied to other storage servers 1200m.

The application server 1100 may store data in one of the storage servers 1200 to 1200m via the network 1300 upon receiving a request from a user or a client to store the data. In addition, the application server 1100 may obtain data from one of the storage servers 1200 to 1200m via the network 1300 upon receiving a request from a user or a client to read the data. For example, the application server 1100 may be implemented as a web server or a database management system (DBMS).

The application server 1100 may access the memory 1120 or the storage device 1150 included in another application server 1100n via the network 1300. Alternatively, the application server 1100 may access the memory 1220 or the storage device 1250 included in the storage server 1200 to 1200m via the network 1300. Accordingly, the application server 1100 may perform various operations on data stored in the application servers 1100 to 1100n and/or the storage servers 1200 to 1200m. For example, the application server 1100 may execute instructions to move or copy data between the application servers 1100 to 1100n and/or the storage servers 1200 to 1200m. In this case, data may be moved from the storage devices 1250 of the storage servers 1200 to 1200m to the memories 1120 of the application servers 1100 to 1100m through the memories 1220 of the storage serves 1200 to 1200m, or directly to the memories 1120 of the application servers 1100 to 1100n. The data moved over the network 1300 may be encrypted data for security or privacy.

The storage server 1200 will now be described by way of example. An interface 1254 may provide a physical connection between the processor 1210 and a controller 1251 and a physical connection between an NIC 1240 and the controller 1251. For example, the interface 1254 may be implemented in a direct attached storage (DAS) scheme in which the storage device 1250 is directly connected to a dedicated cable. In addition, for example, the interface 1254 may be implemented in various interface schemes such as Advanced Technology Attachment (ATA), Serial ATA (SATA), external SATA (e-SATA), Small Computer Small Interface (SCSI), Serial Attached SCSI (SAS), Peripheral Component Interconnection (PCI), PCI express (PCIe), NVMe, IEEE 1394, universal serial bus (USB), secure digital (SD) card, multi-media card (MMC), embedded multi-media card (eMMC), Universal Flash Storage (UFS), embedded Universal Flash Storage (eUFS), or compact flash (CF) card interface.

The storage server 1200 may further include a switch 1230 and a NIC 1240. The switch 1230 may selectively connect the processor 1210 and the storage device 1250 or the NIC 1240 and the storage device 1250 under the control of the processor 1210. Similarly, the application server 1100 may further include a switch 1130 and a NIC 1140.

In one or more example embodiments, the NIC 1240 may include a network interface card, a network adapter, or the like. The NIC 1240 may be connected to the network 1300 by a wired interface, a wireless interface, a Bluetooth interface, an optical interface, or the like. The NIC 1240 may include an internal memory, a DSP, a host bus interface, or the like, and may be connected to the processor 1210 and/or the switch 1230 through a host bus interface. The host bus interface may also be implemented as one of the above-mentioned examples of the interface 1254. In one or more example embodiments, the NIC 1240 may also be integrated with at least one of the processor 1210, the switch 1230, and the storage device 1250.

In the storage server 1200 to 1200m or the application server 1100 to 1100n, the processor may transmit a command to the storage device 1150 or the memories 1120 and 1220 to program or read data. In this case, the data may be data that is error-corrected through am error correction code (ECC) engine. The data may be data processed by data bus inversion (DBI) or data masking (DM), and may include cyclic redundancy code (CRC) information. The data may be data encrypted for security or privacy.

The storage device 1150 and 1250 may transmit control signals and command/address signals to the NAND flash memory device 1252 in response to a read command received from the processor. Accordingly, when data is read from the NAND flash memory device 1252, a read enable (RE) signal may be input as a data output control signal, and may serve to output the data to a DQ bus. A data strobe DQS may be generated using the RE signal. The command and address signals may be latched in a page buffer depending on a rising or falling edge of a write enable (WE) signal.

The controller 1251 may control the overall operation of the storage device 1250. In one or more example embodiments, the controller 1251 may include a static random access memory (SRAMM). The controller 1251 may write data in a NAND flash memory 1252 in response to a write command, or read data from the NAND flash memory 1252 in response to a read command. For example, the write command and/or the read command may be provided from a processor 1210 within the storage server 1200, a processor 1210 within another storage server 120m, or a processor 1110 within an application server 1100n.

A DRAM 1253 may temporarily store (buffer) data to be written in the NAND flash memory 1252 or data read from the NAND flash memory 1252. In addition, the DRAM 1253 may store metadata. The metadata is data generated by the controller 1251 to manage user data or the NAND flash memory 1252. The storage device 1250 may be implemented to include a reset signal generation unit (RSG) 1255 to prevent abnormal reset off and improve product reliability.

The storage device 1250 may be implemented based on the storage devices according to the example embodiments described with reference to FIGS. 1 to 10.

As set forth above, a storage device according to one or more example embodiments may provide a flush function having improved performance while supporting a namespace function.

While example embodiments have been shown and described above, it will be apparent to those skilled in the art that modifications and variations could be made without departing from the scope of the present inventive concept as defined by the appended claims and their equivalents.

What is claimed is:

1. A storage device supporting a flush operation among multiple namespaces, the storage device comprising:
a volatile memory configured to temporarily store a plurality of pieces of data received from a host device;
a non-volatile memory device comprising a plurality of namespaces; and
a controller configured to perform a flush operation in response to a flush command received from the host device,
wherein the controller is further configured to, in the flush operation, move at least one piece of data, stored in the volatile memory and corresponding to the flush command, to at least one of the plurality of namespaces of the non-volatile memory device in a unit smaller than or equal to a namespace.

2. The storage device of claim 1, wherein the flush command comprises:
a data type field including information on a type of a data unit on which the flush operation is to be performed; and
a data information field designating the at least one piece of data on which the flush operation is to be performed.

3. The storage device of claim 2, wherein the data type field comprises a namespace, a stream, a zone, or a die as the type of the data unit on which the flush operation is to be performed.

4. The storage device of claim 3, wherein the data information field comprises one of a namespace identification (NSID) corresponding to the namespace, a stream ID corresponding to the stream, a zone ID corresponding to the zone, or a die number corresponding to the die.

5. The storage device of claim 1, wherein the non-volatile memory device comprises a first namespace and a second namespace,
wherein the volatile memory is configured to store a plurality of pieces of data corresponding to a first stream, and
wherein the controller, in response to the flush command for the first stream, is configured to:
move at least one piece of data corresponding to the first namespace, among the plurality of pieces of data stored in the volatile memory and corresponding to the first stream, to the first namespace in a unit of a stream smaller than the namespace; and
move at least one piece of data corresponding to the second namespace, among the plurality of pieces of data stored in the volatile memory and corresponding to the first stream, to the second namespace in a unit of the stream.

6. The storage device of claim 1, wherein the non-volatile memory device comprises a first namespace and a second namespace,
wherein the volatile memory comprises a first volatile memory and a second volatile memory, and
wherein the controller comprises:
a first non-volatile memory (NVMe) controller configured to, in response to a first flush command, move at least one piece of data, stored in the first volatile memory, to at least one of the first namespace and the second namespace in the unit smaller than or equal to the namespace; and
a second NVMe controller configured to, in response to a second flush command, move at least one piece of data, stored in the second volatile memory, to the second namespace in the unit smaller than or equal to the namespace.

7. The storage device of claim 6, wherein each of the first volatile memory and the second volatile memory comprises at least one piece of data corresponding to a first stream, and
wherein the first NVMe controller, in response to the first flush command for the first stream, is configured to:
move at least one piece of data corresponding to the first stream, among a plurality of pieces of data stored in the first volatile memory and corresponding to the first stream, to the first namespace in a unit smaller than the namespace; and
move at least one piece of data corresponding to the first stream, among the plurality of pieces of data stored in the first volatile memory and corresponding to the first stream, to the second namespace in a unit of a stream.

8. The storage device of claim 7, wherein the second NVMe controller is configured to, in response to the second flush command for the first stream, move at least one piece of data corresponding to the second namespace, among a plurality of pieces of data stored in the second volatile memory and corresponding to the first stream, to the second namespace in the unit of the stream.

9. The storage device of claim 1, wherein the non-volatile memory device comprises a first namespace, a second namespace, and a third namespace,
wherein the volatile memory comprises a first volatile memory, a second volatile memory, and a third volatile memory, and
wherein the controller comprises:
a first non-volatile memory (NVMe) controller configured to, in response to a first flush command, move at least one piece of data, stored in the first volatile memory, to the first namespace in the unit smaller than or equal to the namespace;
a second NVMe controller configured to, in response to a second flush command, move at least one piece of data, stored in the second volatile memory, to the second namespace in the unit smaller than or equal to the namespace; and
a third NVMe controller configured to, in response to a third flush command, move at least one piece of data stored, in the third volatile memory, to the third namespace in the unit smaller than or equal to the namespace.

10. The storage device of claim 9, wherein the first NVMe controller is configured to, in response to the first flush command, move the at least one piece of data, stored in the first volatile memory, to the first namespace in a unit of the namespace,
wherein the second NVMe controller is configured to, in response to the second flush command, move the at least one piece of data, stored in the second volatile memory, to the second namespace in the unit of the namespace, and
wherein the third NVMe controller is configured to, in response to the third flush command, move the at least one piece of data, stored in the third volatile memory, to the third namespace in a unit smaller than the namespace.

11. The storage device of claim 10, wherein the first NVMe controller, the first namespace, the second NVMe controller, and the second namespace correspond to a first domain, and
wherein the third NVMe controller and the third namespace correspond to a second domain, different from the first domain.

12. The storage device of claim 11, wherein at least one of a first host device that issue the first flush command and a second host device that issue the second flush command comprises a power loss prevention circuit.

13. The storage device of claim 11, wherein a period of a flush operation, corresponding to the second domain, is shorter than a period of a flush operation corresponding to the first domain.

14. The storage device of claim 1, wherein the non-volatile memory device comprises a first namespace, a second namespace, and a third namespace,
wherein the volatile memory comprises a first volatile memory and a second volatile memory; and
wherein the controller comprises:
a first non-volatile memory (NVMe) controller configured to, in response to a first flush command, move at least one piece of data stored, in the first volatile memory, to at least one of the first namespace and the second namespace in the unit smaller than or equal to the namespace; and
a second NVMe controller configured to, in response to a second flush command, move at least one piece of data, stored in the second volatile memory, to at least one of the second namespace and the third namespace in the unit smaller than or equal to the namespace.

15. The storage device of claim 14, wherein the first NVMe controller, the first namespace, the second NVMe controller, and the third namespace correspond to a first domain; and
wherein the second namespace corresponds to a second domain, different from the first domain.

16. The storage device of claim 15, wherein a flush operation corresponding to the first domain is performed in a unit of the namespace, and
wherein a flush operation corresponding to the second domain is performed in a unit smaller than the namespace.

17. A storage device supporting a flush operation among multiple namespaces, the storage device comprising:
a volatile memory configured to temporarily store a plurality of pieces of data received from a host;
a non-volatile memory device comprising a plurality of namespaces; and
a controller configured to perform a flush operation to move at least one piece of data, stored in the volatile memory, to the non-volatile memory device in response to a command received from the host,
wherein the non-volatile memory device comprises a first namespace, a second namespace, and a third namespace,
wherein the controller comprises:
a first non-volatile memory (NVMe) controller corresponding to the first namespace and the second namespace and configured to perform a first flush operation and a second flush operation on the first namespace and the second namespace; and
a second NVMe controller corresponding to the second namespace and the third namespace and configured to perform a third flush operation and a fourth flush operation on the second namespace and the third namespace,
wherein the first NVMe controller, the second NVMe controller, the first namespace, and the third namespace correspond to a first domain,
wherein the second namespace corresponds to a second domain, different from the first domain, and
wherein a unit of moving the at least one piece of data in the first flush operation and the fourth flush operation corresponding to the first domain is different from a unit of moving the at least one piece of data in the second flush operation and the third flush operation corresponding to the second domain.

18. The storage device of claim 17, wherein the first flush operation and the fourth flush operation corresponding to the first domain are performed in a unit of a namespace, and
wherein the second flush operation and the third flush operation corresponding to the second domain are performed in a unit smaller than the namespace.

19. A method of performing a flush operation in a storage device that supports multiple namespaces, the flush operation method comprising:
receiving a flush command from a host device;
determining a data type field and a data information field of the flush command;
selecting at least one piece of data to be moved from a volatile memory to a non-volatile memory device, based on the data type field and the data information field; and
moving the selected at least one piece of data from the volatile memory to the non-volatile memory device in a unit smaller than or equal to a namespace.

20. The flush operation method of claim 19, wherein the data type field comprises information on a type of a data unit on which the flush operation is to be performed, and
wherein the data information field comprises information designating the at least one piece of data on which the flush operation is to be performed.
